(19) United States
(12) Patent Application Publication
(10) Pub. No.: US 2006/0028807 A1
(43) Pub. Date: Feb. 9, 2006

(54) Locksmith tool comprising a probe having a light source integrated into the tip thereof

(76) Inventor: Aurelio A. Vigil, Miami, FL (US)

Correspondence Address: John H. Faro, Esq.;Faro & Associates, P.O. Box 4904, Key Biscayne, FL, 33149-4904, US

(21) Appl. No.: 10/911,080

(22) Filed: Aug. 3, 2004

(51) Int. Cl. F21L 4/00; F21V 33/00; B60Q 7/00

(52) U.S. Cl. 362/120; 362/486; 362/186

(57) ABSTRACT

An elongate probe comprising a rod having a handle on one and a manipulative tip on the opposite end, for opening of a locked vehicle door from outside of the vehicle. The manipulative tip of the probe includes and integral light source for illumination of the interior of a vehicle door and, preferably, a slip resistant finish or surface to effect movement of a door handle or door lock associated with such locked door. The integrated light is self-contained in that the power supply, and light source, (e.g. LED, bulb), are within the tip of the of tool, thus, eliminating the need for wires and an external power supply, or modification of the integrated probe to accommodate an external power supply.

### CROSS REFERENCE TO RELATED APPLICATIONS

This application claims the priority filing date of Provisional Application No. 60/490,732, filed Jul. 29, 2003.

### BACKGROUND OF THE INVENTION

1. Field of the Invention

This invention relates to an article of manufacture. More specifically, this invention is directed to a tool suitable for use in locksmithing. This tool is designed for gaining limited access to the interior of a vehicle, and incorporates an intergral light source at the end of the tool, for illumination of the interior of a locked vehicle to fascilitate manipulation of the door handle or door lock with such tool.

2. Description of Prior Art

In many cases the keys to an automobile may be locked inside the vehicle, or the keys unavailable for a variety of reasons, thus, preventing access to the interior of the vehicle. To unlock the vehicle, it is customary for a locksmith, or other emergency personnel, to use a long probe inserted through a gap between the vehicle door frame and the vehicle body, or between the vehicle window and the vehicle body, in the case of a vehicle without a steel frame around the window. Once the tool is inserted into the interior of the vehicle, the tip of the tool is used to move the door lock button or to pull the door lock handle, or push or to push down on the electric door lock button in order to unlock the door.

In the event that it is dark outside, or the vehicle windows have been tinted, it may be nearly impossible to see the door lock button or door handle or even the tip of the tool without additional lighting. The use of flash light to illuminate the inside of the vehicle, under these circumstances, is impractical because the effective manipulation of the tool requires the use of both hands. Moreover, any attempt at lighting of the interior of the vehicle from the outside of the vehicle with, for example, a flash light creates glare and shadows, further complicating the operation of the tool.

Accordingly, there continues to exist a need to provide means for illumination of the interior of a locked vehicle to permit effective manipulation of a tool designed to unlock the vehicle.

### OBJECTS OF THE INVENTION

It is the object of the invention to remedy the above as well as related deficiencies in the prior art.

It is the principle object of the invention to provide an improved locksmith tool, in the form of a long probe having an integral light source, for insertion into a locked vehicle, for manipulation of a lock of locked vehicle.

It is another object of this invention to provide a locksmith tool comprising a long probe having an integral light source integrated into the tip thereof.

It is yet another object of this invention to provide a locksmith tool comprising a long probe wherein the integral lighted tip thereof includes a light transmitting, slip resistance plastic material for manipulation of the vehicle door lock or door handle of the locked door.

Additional objects of this invention include the provision of a protective sleeve for the locksmith tool to prevent abrasion or damage to the locked vehicle door or window by the locksmith tool.

### SUMMARY OF THE INVENTION

The above and related objects are achieved by providing locksmith tool comprising an elongate probe comprising a rod having a handle on one and a manipulative tip on the opposite end. The manipulative tip of the probe includes and integral light source for illumination of the interior of a vehicle door and, preferably, a slip resistant finish or surface to effect movement of a door handle or door lock associated with such locked door. In the preferred embodiments of the invention, the elongated probe is configured to open a car door of a locked vehicle. The manipulative end of this elongated probe is initially inserted into the locked through a gap between the door and the door frame, or alternatively, between the door window and the weather stripping of the door jam. The manipulative end of this probe is positioned proximate to the door handle or door lock or the locked vehicle. The integrated light source on the manipulative end of this tool illuminates the locked door panel and, thus, enables precise positioning of the tool within the locked vehicle, without the locksmith routing around in an effort to snag or engage the door handle or door lock. The integrated light is self-contained in that the power supply, and light source, (e.g. LED, bulb), are within the tip of the of tool, thus, eliminating the need for wires and an external power supply, or modification of the integrated probe to accommodate an external power supply.

In one of the preferred embodiments of this invention, the elongate shaft of the probe is enclosed within a relatively sheath to minimize the abrasion of the vehicle door and/or window by the probe during the insertion and manipulation of the probe within the vehicle by the locksmith. The sheath can comprise a relative soft, compliance material; and, be formed as a coating on the probe. The sheath cover tool can be used with or without the light on the end of the probe tip.

### BRIEF DESCRIPTION OF DRAWINGS

FIG. 1 is a perspective view of a locksmith tool of this invention.

FIG. 2 is an enlarged view of the illuminated tip of the tool shown in FIG. 1.

FIG. 3 is an enlarged isolated view of the self-contained DC power supply and LED element of the illuminated tip of the tool shown in FIG. 1.

FIG. 4 is a perspective view showing the insertion of the tool of FIG. 1 into the interior of a vehicle.

FIG. 5 is a perspective view showing the manipulation of the door handle with the tool of FIG. 4 from within the interior of the vehicle.

FIG. 6 is a perspective view showing the manipulation of the door lock, within the door handle recess, with the tool of FIG. 4 from within the interior of the vehicle.

FIG. 7 is a perspective view showing the manipulation of the door lock on the door arm rest with the tool of FIG. 4 from within the interior of the vehicle.

FIG. 8 is a cross sectional view of the tool of FIG. 1 at AA.

### BRIEF DESCRIPTION OF THE DRAWINGS

The preferred embodiments of this invention are described hereinafter in reference to the foregoing Figures. For ease of expression and comprehension, elements and components of each of these drawings, which depict elements common to more than one Figure, are assigned the same reference numeral.

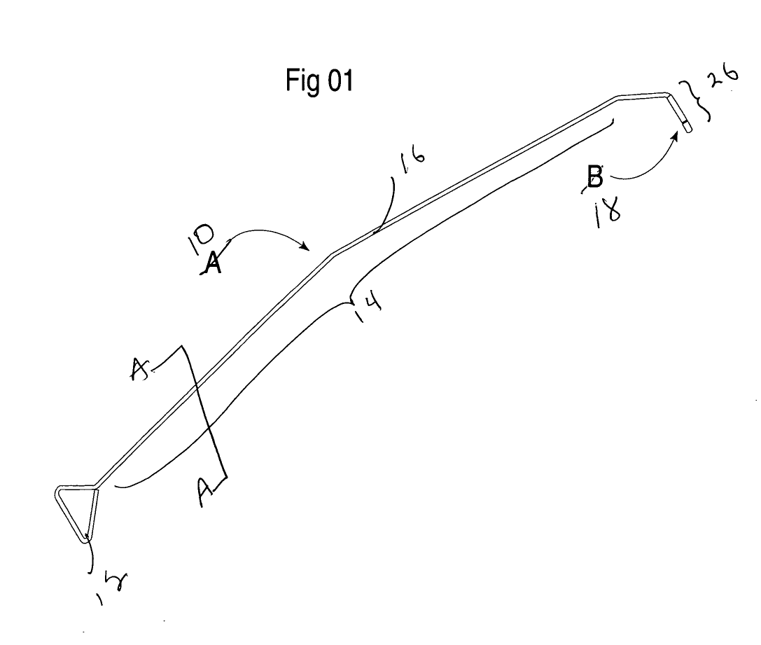

FIG. 1 depicts an improved locksmithing tool of this invention. In the embodiment of the invention illustrated in this Figure, the tool (10) includes a handle (12) and intermediate shaft (14) having a bend (16) approximately midway between the handle (12) and the manipulative tip (18) on the opposite end thereof. This manipulative tip (18) also includes a plurality of bends (16′, 16″) to orient the end of the tool, relative to the position of the handle (12) and the door handle (20) or door lock (22) of the locked door (24).

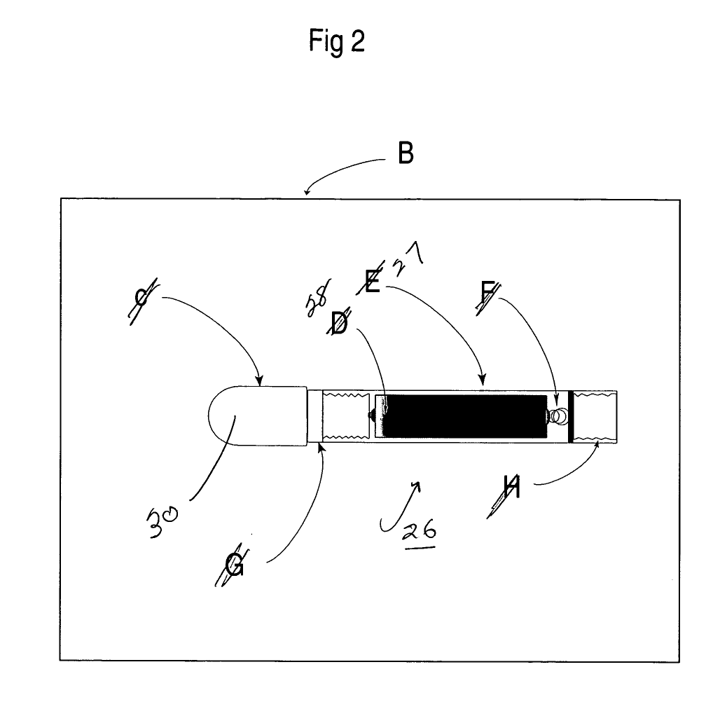

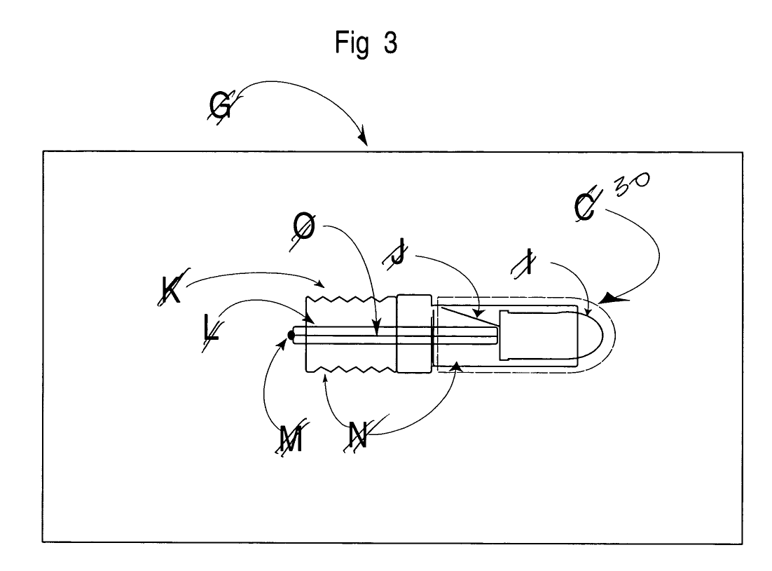

FIG. 2 depicts the terminal section (26) of the manipulative tip (18) of the tool (10). This terminal section (26) includes means for releasable coupling of this terminal section (26) to the manipulative tip (18) of the tool (10). In the embodiment of the invention illustrated in this Figure, the terminal section (26) is threadingly engaged to the manipulative tip (18). This terminal section (26) includes housing (27), a source of electrical power (28) and the light emitting element (30), within the housing (27). FIG. 3 provides an enlarged view of this this light emitting element (30), which comprises a light emitting diode that can be threadingly engaged and disengaged from the terminal section (26) in the event it requires replacement, or as required to change the battery (28) within this terminal section (26) of the manipluative tip (18).

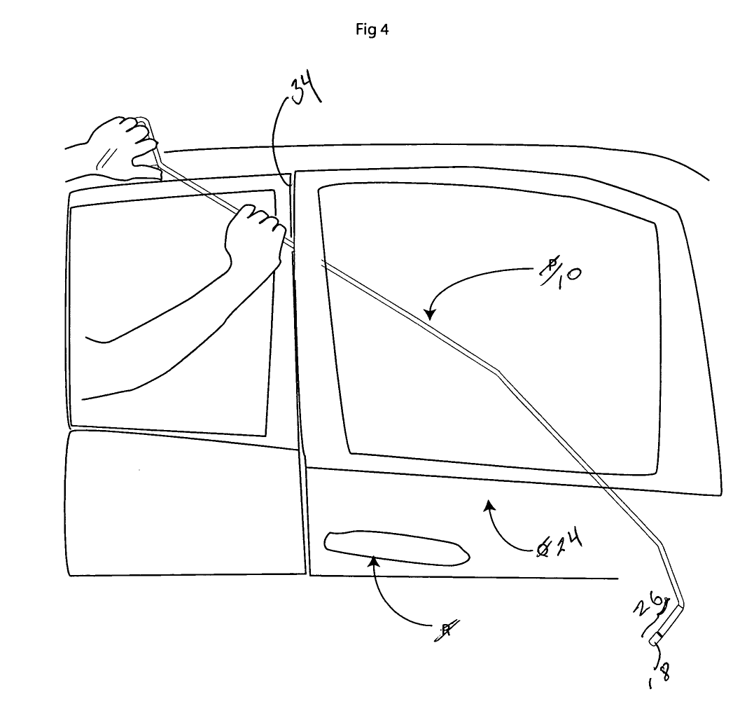

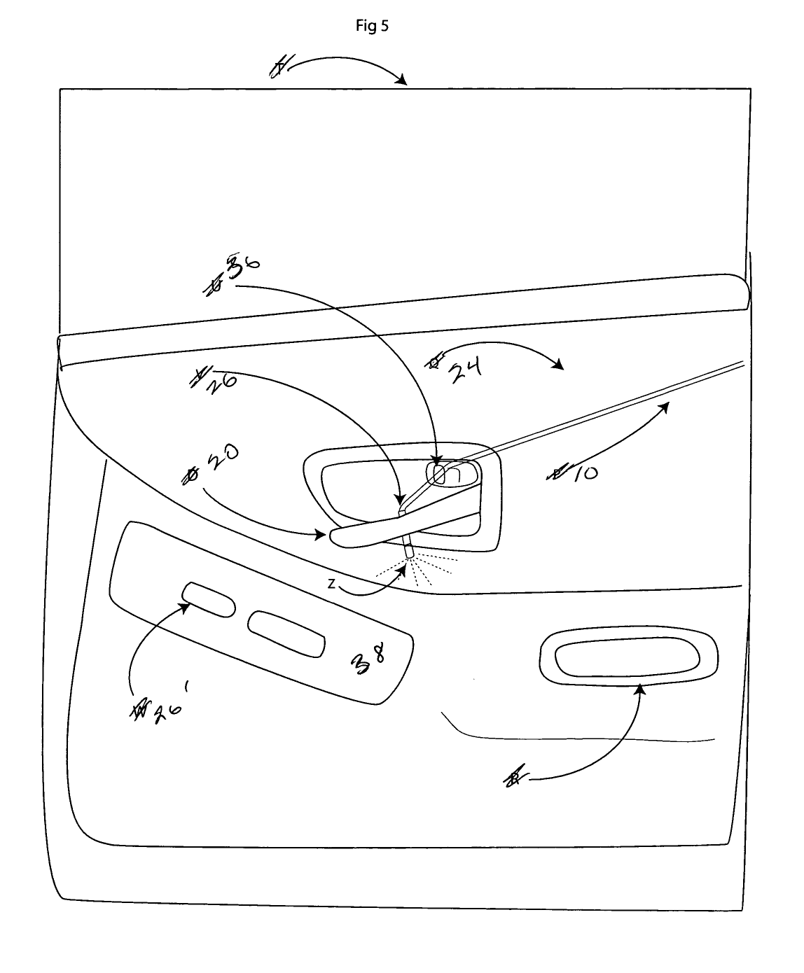

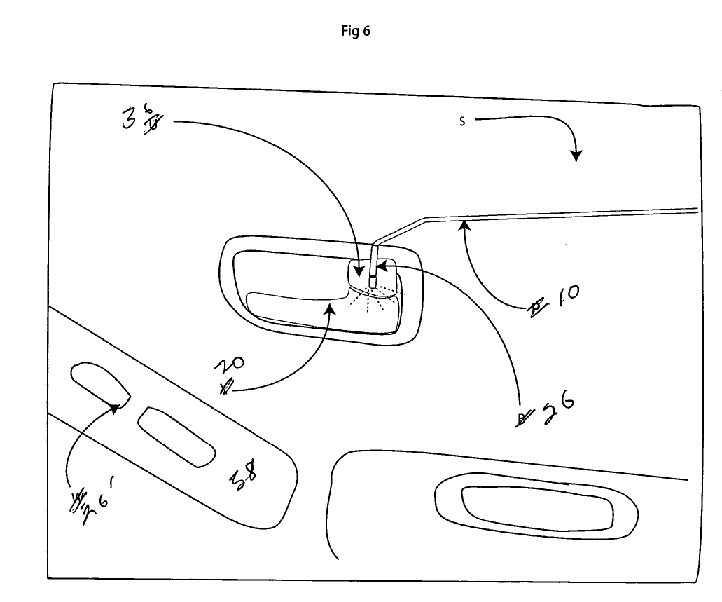

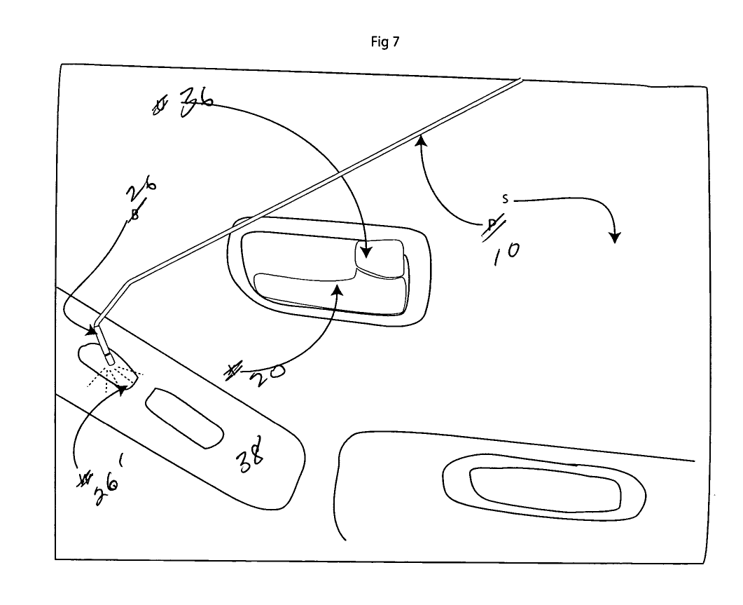

FIG. 4 depicts the insertion of the sectoin of the tool which comprises the manipulative tip (18), between a door (32) and door frame (34), into a locked vehicle door (24). This illustration shows the orientation of the manipulative tip (18) by the locksmith so as to position/orient the terminal section (26) thereof proximate to the interion surface of the locked door (36). FIG. 5 shows the positioning/orientation of this terminal section (26) relative to the interior surface of the locked door (36) from within the vehicle. In FIG. 5, the terminal section (26) of the manipulative tip (18) has engaged the door handle (20) of the locked door (24). Thus, the locksmith simply pulls up the tool and thereby causes the door handle (20) to open the locked door (24) from within the locked vehicle. Because the terminal section (26) is illumninated the locksmith is better able to gauge the position of the terminal section (26) of the tool (10) within the locked vehicle before attempting to open the door. Thus, the terminal section (26) of the manipulative tip (18) is not needlessly probing for the door handle before the locksmith attempts to open the door, thus, minimizing abrasion and damage to the locked vehicle door (24) and the door frame (34). In FIG. 6, the terminal section (26) of the manipulative tip (18) is shown engage the door lock (22) of the locked vehicle door (20). Similarly, in FIG. 7, the terminal section (26) of the manipulative tip (18) is shown engage the door lock (26) located on a console (38) within the locked vehicle, and thereby unlock the locked vehicle door (24).

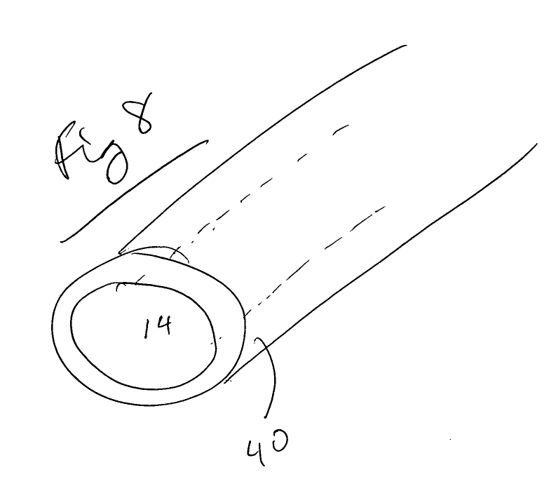

FIG. 8 depicts, in cross-section, a protective sheath (40) on the shaft of the tool. This sheath comprises a relatively soft, compliance coating which is design to both facilitate the movement of the tools shaft into the locked vehicle and yet minimize any abrasion of the door and door frame in the process.

The foregoing Figures and accompanying description have been provided as illustrative of a number of the preferred embodiments of this invention, and not intended to delineate the scope thereof, which is set forth in the claims that follow.

What is claimed is:

1. In a tool kit for gaining access to the interior of a locked automotive vehicle which includes a wedge and an elongate probe, wherein the probe includes a tip for manipulating the interior door handle and/or the door locking mechanism, wherein the improvement comprises:
An elongate probe having a manipulative tip which an integrated light source for illumination of the interior of a locked automotive vehicle proximate to said locked door so as to fascilitate placement and operation of said manipulative tip of said probe relative to said interior door handle and/or said door lock from within said vehicle,
said integrated light source having a self-contained source of DC power electrically coupled to a means for converting said DC power to a source of illumination.

2. The tool kit of claim 1, wherein the manipulative tip of said elongate probe comprises a transparent slip resistant material.

3. The tool kit of claim 1, wherein the source of illumination of said light source within said manipulative tip comprises a light emitting diode.

4. The tool kit of claim 1, wherein the said elongate probe includes along its length a sheath.

5. In a tool kit for gaining access to the interior of a locked automotive vehicle which includes a wedge and an elongate probe, wherein the probe includes a tip for manipulating the interior door handle and/or the door locking mechanism, wherein the improvement comprises:
a coating or sleeve essentially completely enveloping said probe so as to prevent abrasion of surfaces that come in constact with said probe during use.
